(19) United States
(12) Patent Application Publication
(10) Pub. No.: US 2017/0060566 A1
(43) Pub. Date: Mar. 2, 2017

(54) METHOD AND DEVICE FOR INSTALLING PLUG-IN OF SMART DEVICE

(71) Applicant: Xiaomi Inc., Beijing (CN)

(72) Inventors: Feiyun Li, Beijing (CN); Hao Chen, Beijing (CN); Enxing Hou, Beijing (CN)

(73) Assignee: Xiaomi Inc., Beijing (CN)

(21) Appl. No.: 15/234,536

(22) Filed: Aug. 11, 2016

(30) Foreign Application Priority Data
Aug. 28, 2015 (CN) 201510542313.4

(51) Int. Cl. G06F 9/445; H04L 12/28

(52) U.S. Cl. CPC G06F 8/65; H04L 12/2814

(57) ABSTRACT

The present disclosure relates to a method and a device for installing a plug-in of a smart device in a mobile terminal. An integrated application is disclosed for controlling a plurality of smart devices using one mobile terminal based on installation of plug-ins each for one of the plurality of smart devices. In one embodiment, a method for installing a plurality of plug-ins each for a plurality of smart home devices in a mobile terminal is disclosed. The method includes receiving a selection instruction for selecting a smart device; determining whether a plug-in for the smart device was installed previously, sending a plug-in acquiring request to a server when the plug-in for the smart device was not installed previously, wherein the plug-in acquiring request comprises an identifier of the smart device, receiving a plug-in installation package for the plug-in sent by the server according to the plug-in acquiring request; and running the plug-in installation package and installing the plug-in in an application, wherein the application is configured to control the plurality of smart device each via one of the plurality of plug-ins.

This application is based on and claims priority to Chinese Patent Application Serial No. CN 201510542313.4, filed with the State Intellectual Property Office of P. R. China on Aug. 28, 2015, the entire content of which is incorporated herein by reference.

### TECHNICAL FIELD

The present disclosure relates to smart home technology, and more particularly to a method and a device for installing a plug-in of a smart device.

### BACKGROUND

Smart home refers to an ecosystem that provides efficient control and management of residential facilities and environment, and family affairs. Smart home includes but is not limited to various smart devices, home appliances, and sensors integrated internally and connected with external devices and service agencies using comprehensive wiring, network communication, security, automation, and multimedia technologies. Smart home offers improved safety, convenience, comfort, energy efficiency, and artistry to residents. Smart home appliances and sensors (herein generally referred to as “home devices”) may be controlled by a user via a central management platform or application (app) installed on a mobile device such as a mobile phone. The control app manages each individual home device. The management of software component of each smart home device in the central control app may be burdensome because (1) there may be numerous home devices to be managed, (2) each of these devices may be provided with periodically updated control software by their manufacturers, and (3) home devices may be replaced when they become outdated or simply fail. Smart control units of home devices, appliances in particular, may become outdated easily because home appliances typically have lifetimes on the order of decades yet control units installed in them may become incompatible with new technological advancement within a couple years.

### SUMMARY

In view of the above, the present disclosure provides methods and devices for installing a plug-in of home devices in a smart mobile device. This summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a method for installing a plurality of plug-ins each for a plurality of smart home devices in a mobile terminal is disclosed. The method includes receiving a selection instruction for selecting a smart device; determining whether a plug-in for the smart device was installed previously; sending a plug-in acquiring request to a server when the plug-in for the smart device was not installed previously, wherein the plug-in acquiring request comprises an identifier of the smart device; receiving a plug-in installation package for the plug-in sent by the server according to the plug-in acquiring request; and running the plug-in installation package and installing the plug-in in an application, wherein the application is configured to control the plurality of smart device each via one of the plurality of plug-ins.

In another embodiment, a device for installing a plurality of plug-ins each for one of a plurality of smart devices is disclosed. The device includes, comprising processor; and a memory, configured to store instructions executable by the processor; wherein the processor is configured to receive a selection instruction for selecting a smart device, determine whether a plug-in for the smart device was installed previously, send a plug-in acquiring request to a server when the plug-in of the smart device was not installed previously, wherein the plug-in acquiring request comprises an identifier of the smart device, receive a plug-in installation package for the plug-in sent by the server according to the plug-in acquiring request, and run the plug-in installation package and install the plug-in in an application, wherein the application is configured to control the plurality of smart devices each via one of the plurality of plug-ins.

In yet another embodiment, a non-transitory computer-readable storage medium is disclosed. The Computer-readable storage medium has stored therein instructions that, when executed by a processor of a mobile terminal, cause the mobile terminal to install a plurality of plugins each for one of a plurality of smart devices by receiving a selection instruction for selecting a smart device; determining whether a plug-in for the smart device was installed previously; sending a plug-in acquiring request to a server when the plug-in of the smart device was not installed previously, wherein the plug-in acquiring request comprises an identifier of the smart device; receiving a plug-in installation package for the pug-in sent by the server according to the plug-in acquiring request; and running the plug-in installation package and installing the plug-in in an application, wherein the application is configured to control the plurality of smart devices each via one of the plurality of plug-ins.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a schematic diagram of an application scene in which a method for installing a plug-in of a smart device according to an example embodiment is applied.

FIG. 2 is a flow chart of a method for installing a plug-in of a smart device according to an example embodiment.

FIG. 3 is a flow chart of a method for installing a plug-in of a smart device according to an example embodiment.

FIG. 4 is a flow chart of a method for installing a plug-in of a smart device according to an example embodiment.

FIG. 5 is a flow chart of a method for installing a plug-in of a smart device according to an example embodiment.

FIG. 6 is a block diagram of a device for installing a plug-in of a smart device according to an example embodiment.

FIG. 7 is a block diagram of a device for installing a plug-in of a smart device according to an example embodiment.

FIG. 8 is a block diagram of a device for installing a plug-in of a smart device according to an example embodiment.

FIG. 9 is a block diagram of a device for installing a plug-in of a smart device according to an example embodiment.

FIG. 10 is a block diagram of a device for installing a plug-in of a smart device according to an example embodiment.

FIG. 11 is a block diagram of a device for installing a plug-in of a smart device according to an example embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise indicated. The implementations set forth in the following description of exemplary embodiments do not represent all implementations consistent with the invention. Instead, they are merely examples of apparatuses and methods consistent with aspects related to the invention as recited in the appended claims.

The terms used herein are merely for describing a particular embodiment, rather than limiting the present disclosure. As used in the present disclosure and the appended claims, terms in singular forms such as “a”, “said” and “the” are intended to also include plural forms, unless explicitly dictated otherwise. It should also be understood that the term “and/or” used herein means any one or any possible combination of one or more associated listed items.

It should be understood that, although it may describe an element with a term first, second, or third, etc., the element is not limited by these terms. These terms are merely for distinguishing among elements of the same kind. For example, without departing from the scope of the present disclosure, a first element can also be referred to as a second element. Similarly, a second element can also be referred to as a first element. Depending on the context, a term “if” as used herein can be interpreted as “when”, “where” or “in response to”.

By way of introduction, the present disclosure describes methods and devices that utilize a centralized computer manager to control various smart home devices. For user convenience, the central manager may be embodied as a controller application (app) installed in a mobile device. Rather than individually installing control software for each smart home device, the user may control the various smart home devices via plug-ins to the central controller app. Each plug-in may comprise software components providing a user interface and a control interface that is responsible for communicating user instructions to the corresponding smart home device. The plug-ins may be managed by a single server or by a plurality of application servers each corresponding to a particular smart home device. The installation, removal, and upgrade of the plug-ins are automatically managed by the controller app in communication with the servers. The management of smart home devices is thus streamlined and the size of the control software may be prevented from growing in an uncontrolled fashion, saving storage space, improving computing speed, and reducing power consumption of the mobile device.

The term “mobile terminal” may hereinafter be interchangeably referred to as “mobile device”, “terminal”, “terminal device”, “smart phone”, “smart mobile phone”, “mobile phone” and the like. The term “plug-in” refers to a collection of software components that may be installed in a mobile terminal and act as an intermediate of communication between the user, the mobile terminal, and a corresponding home device. A plug-in may include a user operation interface for receiving user instructions and a control interface in communication with a corresponding smart home device for the user to manage the corresponding smart home device from the mobile terminal. The term smart home device generally refers to an intelligent home device or appliance and may be alternatively referred to as home device.

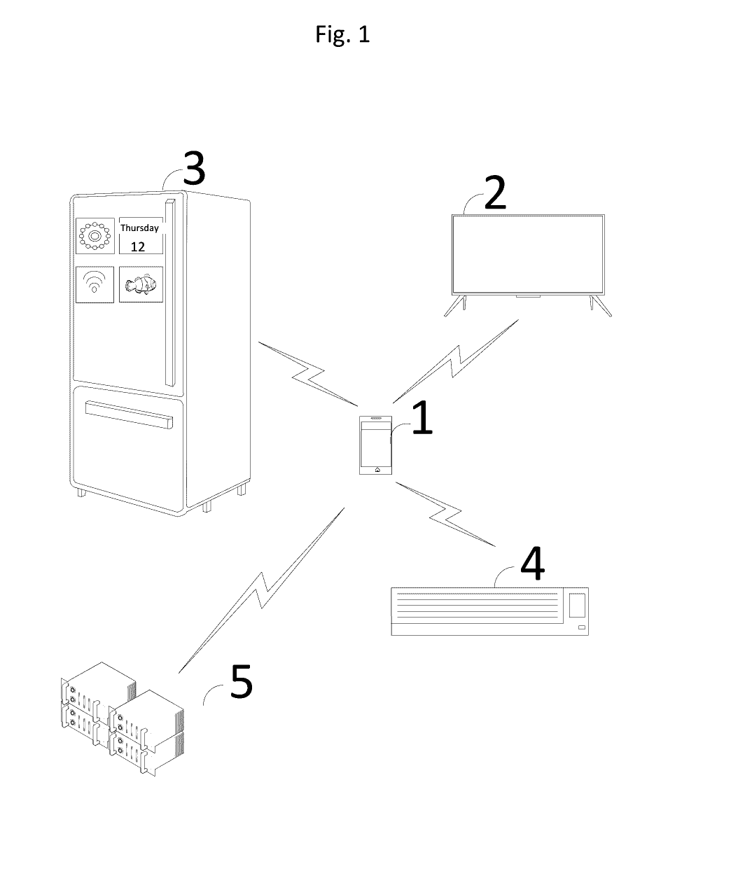

FIG. 1 illustrates a scenario where method embodiments according to the present disclosure for installing plug-ins of smart devices may be applied. A central controller application for controlling a plurality of smart home devices may be installed in the mobile terminal 1. Three exemplary smart home devices, 2, 3, and 4, may be wirelessly connected to the mobile terminal 1. The smart home devices may include but are not limited to a smart air conditioner, a smart TV, a smart washer, a smart refrigerator, a robot cleaner, a smart curtain, a security system, an illuminating/lighting system, an audio-visual system, and a smart electric plug. The smart devices may be of an identical type, or may be of different types, e.g. the smart device 2 may be a smart TV, the smart device 3 may be a smart refrigerator, and the smart device 4 may be a smart air conditioner. Further, the mobile terminal may be in communication with one or more servers 5. The servers may be used as depository for software components such as plug-ins needed for the central controller application in managing the various smart home devices. Servers 5 may be a group of centralized servers for managing software components for all smart home devices. Alternatively, servers 5 may comprise application servers each dedicated to a particular smart home device. The smart terminal 1 used for user control of the smart home devices is merely exemplary. Other devices may be used as the central controller. For example, the mobile terminal 1 may be replaced by a dedicated central controller device such as a wearable device in communication with the smart devices directly or via a mobile terminal.

It should be noted that, the scenario shown in FIG. 1 is exemplary and explanatory, and shall not be construed to limit the present disclosure, e.g. a number of the smart devices connected to the mobile terminal 1 may be one, two, four or five, etc.

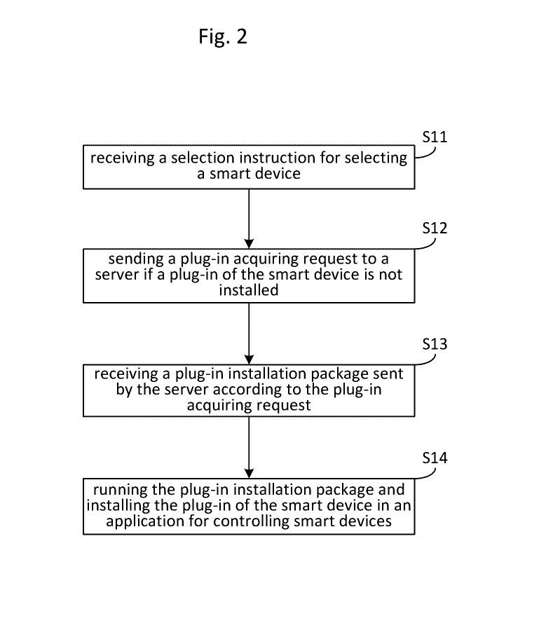

FIG. 2 is a flow chart of a method for installing a plug-in of a smart home device into the terminal according to an example embodiment. The method may be performed by and in the terminal. In step S11, a selection instruction for selecting a smart home device is received. Selection instruction may be given by the user via an interface of the central app. The user interface of the central app may provide a list of smart home devices for user selection of a smart home device to be controlled. In step S12, if a plug-in of the selected smart home device is not installed, a plug-in acquiring request is sent to a corresponding server. The corresponding server may be an application server for the selected home device managed and provided by the manufacturer of the device or a third party service provider. Alternatively, there may be a single server that manages plug-ins for all the home devices. In the present embodiment, the plug-in acquiring request may include an identifier of the smart device such that the server, particularly in the situation that a single server is used to manage all home device plug-ins, can determine the correct plug-ins to be delivered to the terminal. In step S13, a plug-in installation package sent by the server according to the plug-in request is received by the terminal. In step S14, the plug-in installation package is run and the plug-in is installed in the central app.

Thus, in embodiments of the present disclosure, the control app in the terminal is configured to control each smart device via a plug-in for each smart device rather than pre-installed software components. Each plug-in comprises components that provide a control interface to the user. If the plug-in of a particular smart device is not installed when the user desires to control that particular smart home device, the plug-in acquiring request is sent to the server (either a specific application server of the smart home device, or a single server for all smart home devices), and the plug-in installation package sent by the server according to the plug-in acquiring request is received by the control app. The plug-in installation package is then run and the plug-in is installed in the application. The particular smart home device is then controlled via the plug-in. Since the number of plug-ins installed in the application may be controlled to increase or decrease according to smart devices controlled by the application, the size of the application controlling all the smart devices is effectively limited, the operation speed of the terminal is increased, and the user experience is improved.

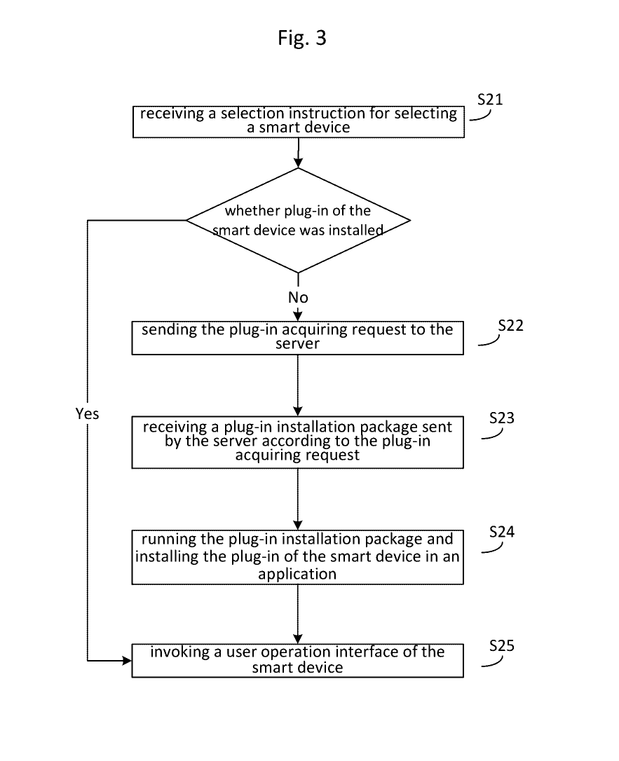

FIG. 3 is a flow chart of another method for installing a plug-in of a smart home device in a terminal according to an example embodiment. In step S21, a selection instruction for selecting a smart device is received from the user. If a plug-in of the smart device is not installed, steps S22-S25 are executed. If the plug-in of the smart device has been installed, step S25 is executed. In an implementation of the present embodiment, step S21 may comprise obtaining information of a plurality of smart home devices sent by the server either on the initiative of the server or upon requests from the control app of the terminal; outputting the information of the plurality of smart home devices (such as the IDs and names of the smart devices) on a smart home device selection interface in the control app; and receiving the selection input from the user via the smart home device selection interface. In practical use, when the user initiate the control app and attempt to control smart home devices via the terminal, the terminal may send requests for smart device information to corresponding application servers and the servers may send information of a plurality of smart devices bound to the terminal to the terminal. The terminal displays the information of the plurality of smart devices on a smart device selection interface of the control app and receives a selection input from the user via the smart device selection interface, thus determining the smart devices to be controlled. Alternatively, the requests for smart device information may be sent to a single server that maintains information and plug-ins for all smart home devices.

After the terminal determines that the plug-in for the smart home device to be controlled was not installed and in step S22, a plug-in acquiring request is sent to a server. In the present embodiment, the plug-in acquiring request includes an identifier of the smart device. In an implementation of the present embodiment, the method may further include the following operations. If the plug-in has been installed but a version of the plug-in is not the latest version, the plug-in may be considered not installed and the plug-in acquiring request is sent to the server. As the number of smart devices increases, plug-ins of the smart devices are developed and upgraded accordingly, and a plug-in downloaded from the server may not originally exist in the terminal. In the meanwhile, a smart home device will be upgraded, and the plug-in of the smart home device will be updated accordingly. Further, the plug-ins downloaded by the terminal from the server previously may not be the latest version.

In step S23, a plug-in installation package, such as an APK (Android Package), sent by the server according to the plug-in acquiring request is received and the package is configured to install the plug-in of the smart device in the application. In step S24, the plug-in installation package is run and the plug-in is installed in an application. Thus, in the embodiment of FIG. 3, the application is configured to control the smart device via the plug-in. The plug-in of the smart device includes a user operation interface of the smart device and a control interface of the smart device. In step S25, (either the plug-in for the smart home device to be controlled was installed previously or is just requested and installed), the control app switches to the user operation interface of the smart home device. It can be understood that, in the user operation interface of the smart device, a user may input a control instruction (e.g. opening or closing the smart device), and the terminal calls a control interface of the smart device according to the control instruction, thus performing corresponding control on the smart device.

Thus, in the embodiment of FIG. 3, when the plug-in of the smart device is not installed, the plug-in acquiring request is sent to the server, the plug-in installation package sent by the server according to the plug-in acquiring request is received, and the plug-in installation package is run and the plug-in is installed in the application, in which the application is configured to control the smart device via the plug-in. Since plug-ins installed in the application may be controlled to increase or decrease according to smart devices controlled by the application, the size of the application controlling all the smart devices is effectively prevented from becoming larger and larger, the operation speed of the terminal is increased, and the user experience is good.

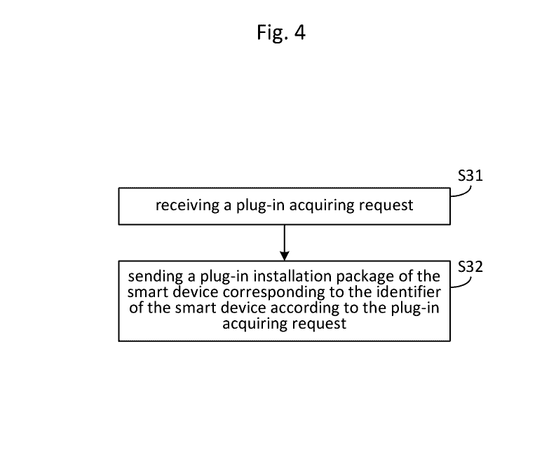

FIG. 4 is a flow chart of a method for installing a plug-in of a smart device according to an example embodiment performed on a server. In step S31, a plug-in acquiring request is received. In the present embodiment, the plug-in acquiring request includes an identifier of the smart home device. The plug-in installation package of the smart home device comprises at least the identifier of the smart device is sent according to the plug-in acquiring request. Further, the plug-in installation package is configured to install a plug-in of the smart home device in an application. The application is configured to control the smart home device via the plug-in. The plug-in of the smart device includes a user operation interface of the smart home device and a control interface of the smart device.

Thus, in embodiments of the present disclosure, a plug-in installation package of a smart home device corresponding to an identifier of the smart device is sent by the server according to the plug-in acquiring request, in which the plug-in of the smart device includes a user operation interface of the smart device and a control interface of the smart device. The application is configured to control the smart device via the plug-in. Since plug-ins installed in the application may be controlled to increase or decrease according to smart devices controlled by the application, the size of the application controlling all the smart devices is effectively kept from becoming larger and larger. The operation speed of the terminal is thus increased, providing improved user experience.

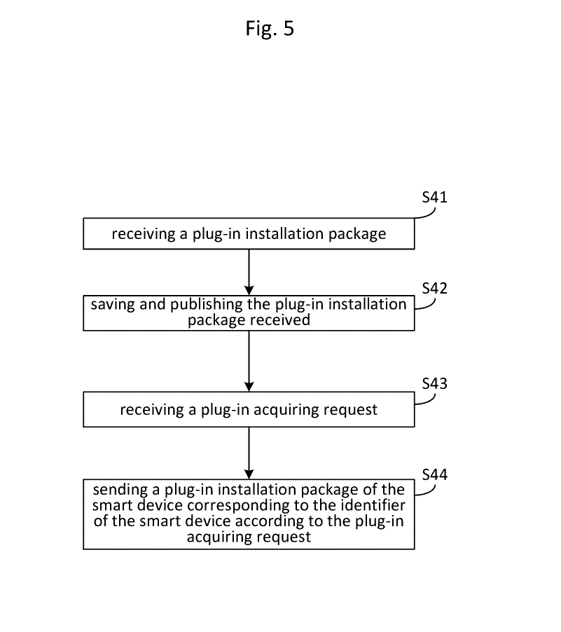

FIG. 5 is another flow chart of a method for installing a plug-in of a smart device according to an example embodiment performed by a server. In step S41, a plug-in installation package is received from the developer. The plug-in installation package may be developed by a developer based on a plug-in development kit. The plug-in development kit, i.e. a SDK (Software Development Kit), may be published on a website for being downloaded and used by the developer. A SDK may be a convenient tool for developers to develop a user operation interfaces and a control interface for each smart home device. Alternatively, the SDK may include a smart device interface library and a user operation interface library. The smart device interface library is configured to provide an interface (e.g. a plugin_lib) for an application to control a smart device via a plug-in of the smart device, and the user operation interface library is configured to provide an operation interface (e.g. a common_ui) for a user to control the application. Development of the user operation interface of a smart home device may be realized by calling the user operation interface library, and developing the control interface of the smart device may be realized by calling the smart device interface library. In step S41, the plug-in installation package is received by a server. In the case that each smart home device is in communication with a dedicated application server, the application server obtains the plug-ins (original and upgraded) from the developer and store the plug-ins in the application server. If there is a single server for managing the plug-ins of all home smart devices, then the developers of plug-in of each smart home device may supply the plug-ins as they are developed and upgraded to the single server for maintenance and distribution to the control application in the mobile terminal.

In step S42, the plug-in installation package received is saved and published in the server for distribution. In one implementation, the plug-in installation package saved and published by the server may be sent by one particular terminal (the developer may upload and publish the package via a specific terminal device), and all terminals may download various kinds of plug-in installation packages via the server, thus realizing a control on multiple smart devices developed by the same developer by different terminal device. In this implementation, to ensure that the publication of plug-ins is by authorized developer, signature information may be incorporated into the plug-in installation package and the server checks the signature information in the plug-in installation package upon receiving it before publishing the received package. The server may not publish the plug-in installation package until it passes signature checking. The signature may be a digital signature known in the art. A plug-in package received by the server may be a plug-in installation package which has not been previously saved in the server or may be an updated version of the plug-in installation package saved previously in the server.

In step S43, a plug-in acquiring request is received by the server from a terminal device. The plug-in acquiring request includes an identifier of the smart device. In step S44, a plug-in installation package of the smart home device corresponding to the identifier of the smart home device is sent by the server to the terminal device according to the plug-in acquiring request. In the present disclosure, the plug-in installation package is configured to install a plug-in of the smart home device in an application. The application is configured to control the smart home device via the plug-in. The plug-in of the smart device includes a user operation interface of the smart device and a control interface of the smart device.

Thus, in embodiment of FIG. 5, a plug-in installation package of the smart home device corresponding to the identifier of the smart device is sent according to the plug-in acquiring request, in which the plug-in installation package is configured to install the plug-in of the smart device in the application, and the application is configured to control the smart device via the plug-in. Since plug-ins installed in the application may be controlled to increase or decrease according to smart devices controlled by the application, the size of the application controlling all the smart devices is effectively kept from becoming larger and larger, the operation speed of the terminal is increased, improving user experience.

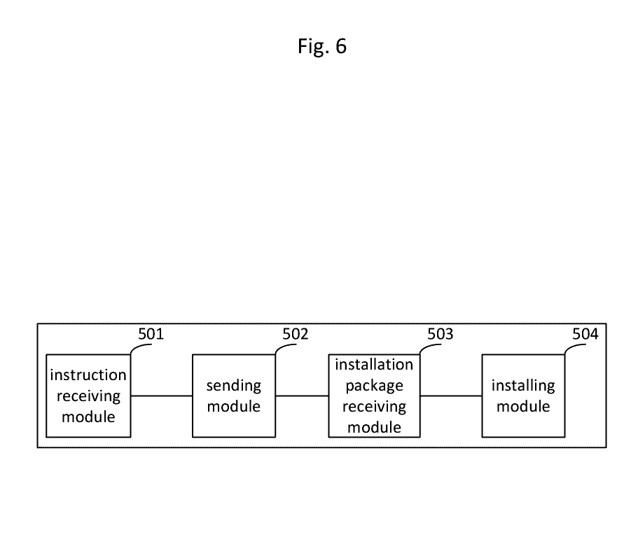

FIG. 6 is a block diagram of a device for installing a plug-in of a smart device according to an example embodiment. As shown in FIG. 6, the device includes an instruction receiving module 501, a sending module 502, an installation package receiving module 503 and an installation module 504. The instruction receiving module 501 is configured to receive a selection instruction for selecting a smart device. The sending module 502 is configured to send a plug-in acquiring request to a server if a plug-in of the smart device is not installed, in which the plug-in acquiring request includes an identifier of the smart device. The installation package receiving module 503 is configured to receive a plug-in installation package sent by the server according to the plug-in acquiring request. The installation module 504 is configured to run the plug-in installation package and install the plug-in in an application, in which the application is configured to control the smart device via the plug-in.

In embodiments of the present disclosure, if the plug-in of the smart device is not installed, the plug-in acquiring request is sent to the server, the plug-in installation package sent by the server according to the plug-in acquiring request is received, the plug-in installation package is run and the plug-in is installed in the application, in which the application is configured to control the smart device via the plug-in. Since plug-ins installed in the application may be controlled to increase or decrease according to smart devices controlled by the application, the size of the application controlling all the smart devices is effectively avoided from becoming larger and larger, the operation speed of the terminal is increased, and the user experience is good.

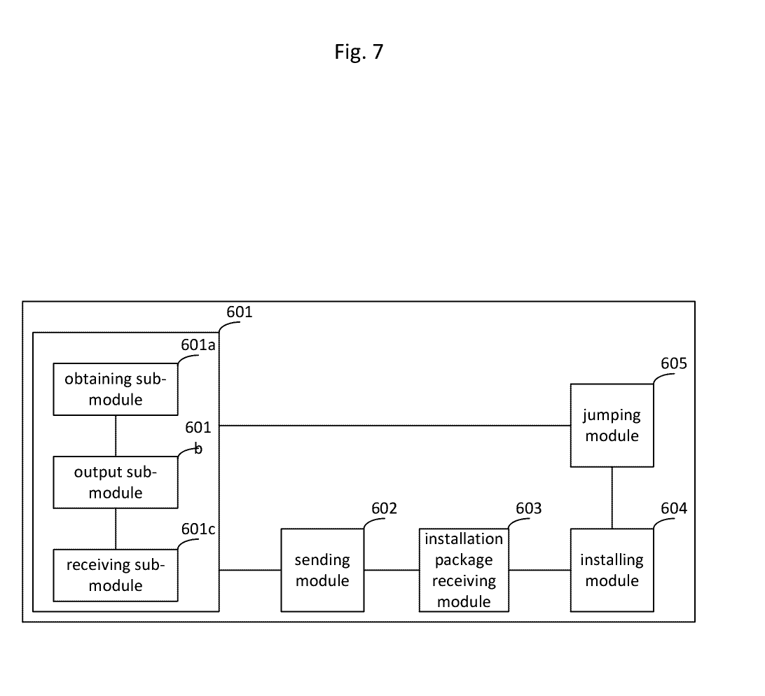

FIG. 7 is a block diagram of a device for installing a plug-in of a smart device according to an example embodiment. As shown in FIG. 7, the device includes an instruction receiving module 601, a sending module 602, an installation package receiving module 603 and an installation module 604. The instruction receiving module 601 is configured to receive a selection instruction for selecting a smart device. The sending module 602 is configured to send a plug-in acquiring request to a server if a plug-in of the smart device is not installed, in which the plug-in acquiring request includes an identifier of the smart device. The installation package receiving module 603 is configured to receive a plug-in installation package sent by the server according to the plug-in acquiring request. The installation module 604 is configured to run the plug-in installation package and install the plug-in in an application, in which the application is configured to control the smart device via the plug-in. In one implementation of the present embodiment, the device may further include a jumping module 605. The jumping module 605 is configured to jump to a user operation interface of the smart device if the plug-in has been installed.

In another implementation of the present embodiment, the instruction receiving module 601 may include an obtaining sub-module 601a, an output sub-module 601b, and a receiving sub-module 601c. The obtaining sub-module 601a is configured to obtain information of a plurality of smart devices sent by the server. The output sub-module 601b is configured to output the information of the plurality of smart devices on a smart device selection interface. The receiving sub-module 601c is configured to receive the selection instruction input via the smart device selection interface. In yet another implementation of the present embodiment, the device may further include a jumping module 605. The jumping module 605 is configured to jump to a user operation interface of the smart device after the plug-in is installed in the application configured to control smart devices. In yet another implementation of the present embodiment, the sending module 602 may be further configured to send the plug-in acquiring request to the server if the plug-in has been installed but a version of the plug-in is not the latest version.

In embodiments of the present disclosure, if the plug-in of the smart device is not installed, the plug-in acquiring request is sent to the server, the plug-in installation package sent by the server according to the plug-in acquiring request is received, the plug-in installation package is run and the plug-in is installed in the application, in which the application is configured to control the smart device via the plug-in. Since plug-ins installed in the application may be controlled to increase or decrease according to smart devices controlled by the application, the size of the application controlling all the smart devices is effectively avoided from becoming larger and larger, the operation speed of the terminal is increased, improving user experience.

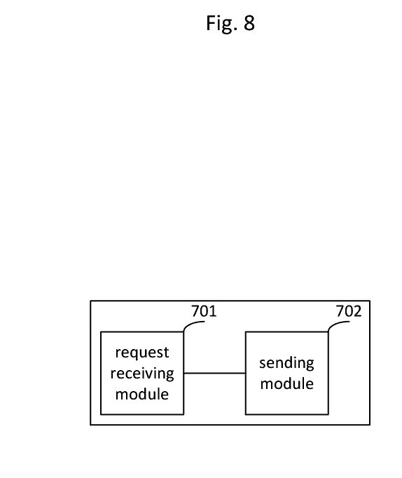

FIG. 8 is a block diagram of a device for installing a plug-in of a smart device according to an example embodiment. As shown in FIG. 8, the device includes a request receiving module 701 and a sending module 702. The request receiving module 701 is configured to receive a plug-in acquiring request, the plug-in acquiring request including an identifier of the smart device. The sending module 702 is configured to send a plug-in installation package of the smart device corresponding to the identifier of the smart device according to the plug-in acquiring request, in which the plug-in installation package is configured to install the plug-in in an application, and the application is configured to control the smart device via the plug-in.

In embodiments of the present disclosure, a plug-in installation package of the smart device corresponding to the identifier of the smart device is sent according to the plug-in acquiring request, in which the plug-in installation package is configured to install the plug-in of the smart device in the application, and the application is configured to control the smart device via the plug-in. Since plug-ins installed in the application may be controlled to increase or decrease according to smart devices controlled by the application, the size of the application controlling all the smart devices is effectively avoided from becoming larger and larger, the operation speed of the terminal is increased, improving user experience.

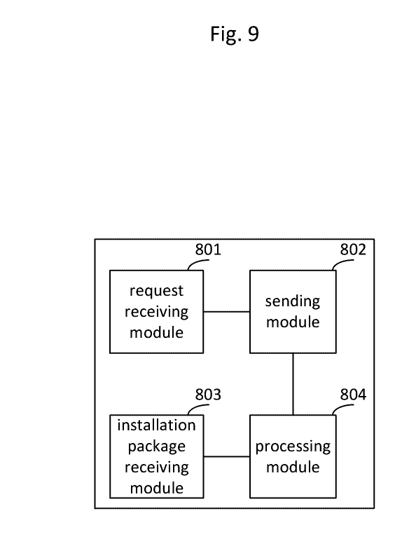

FIG. 9 is a block diagram of a device for installing a plug-in of a smart device according to an example embodiment. As shown in FIG. 9, the device includes a request receiving module 801 and a sending module 802. The request receiving module 801 is configured to receive a plug-in acquiring request, the plug-in acquiring request including an identifier of the smart device. The sending module 802 is configured to send a plug-in installation package of the smart device corresponding to the identifier of the smart device according to the plug-in acquiring request, in which the plug-in installation package is configured to install the plug-in in an application, and the application is configured to control the smart device via the plug-in. In an implementation of the present embodiment, the device may further include an installation package receiving module 803 and a processing module 804. The installation package receiving module 803 is configured to receive the plug-in installation package. The processing module 804 is configured to save and publish the plug-in installation package received.

In embodiments of the present disclosure, a plug-in installation package of the smart device corresponding to the identifier of the smart device is sent according to the plug-in acquiring request, in which the plug-in installation package is configured to install the plug-in of the smart device in an application, and the application is configured to control the smart device via the plug-in. Since plug-ins installed in the application may be controlled to increase or decrease according to smart devices controlled by the application, the size of the application controlling all the smart devices is effectively limited, the operation speed of the terminal is increased, improving user experience.

With respect to the devices in the above embodiments, the specific operation modes of individual modules therein have been described in detail in the embodiments regarding the method, which will not be elaborated herein.

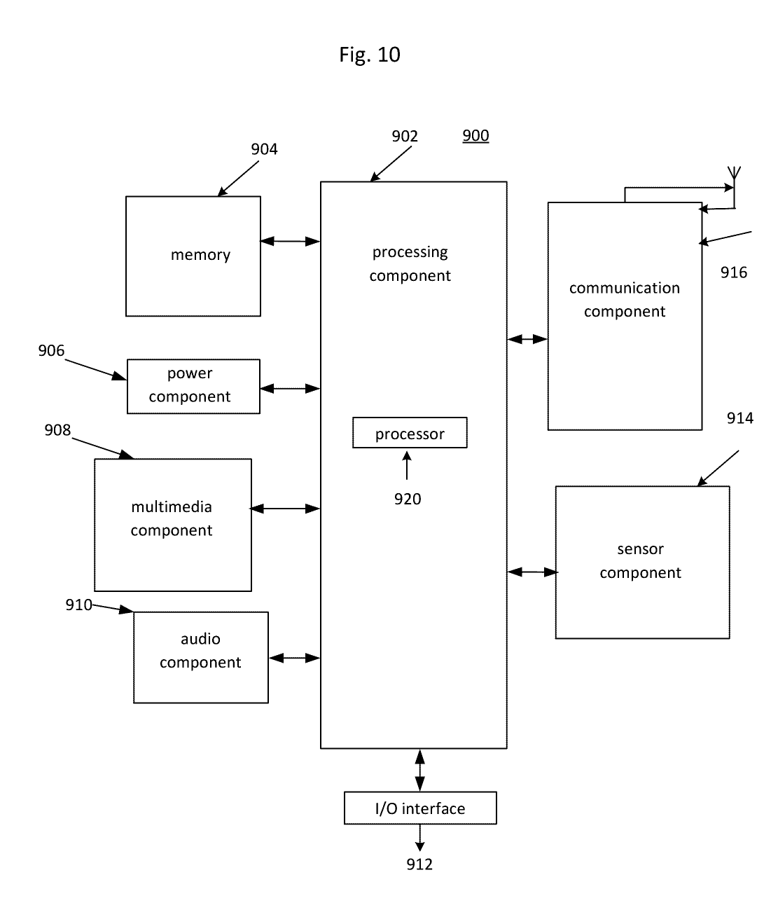

FIG. 10 is a block diagram of a device 900 for installing a plug-in of a smart device according to an example embodiment. For example, the device 900 may be a mobile phone, a computer, a digital broadcasting terminal, a messaging device, a game console, a tablet device, a fitness equipment, a Personal Digital Assistant PDA, etc.

Referring to FIG. 10, the device 900 may include the following one or more components: a processing component 902, a memory 904, a power component 906, a multimedia component 908, an audio component 910, an Input/Output (I/O) interface 912, a sensor component 914, and a communication component 916.

The processing component 902 controls overall operations of the device 900, such as the operations associated with display, telephone calls, data communications, camera operations, and recording operations. The processing component 902 may include one or more processors 920 to execute instructions to perform all or part of the steps in the above described methods. Moreover, the processing component 902 may include one or more modules which facilitate the interaction between the processing component 902 and other components. For instance, the processing component 902 may include a multimedia module to facilitate the interaction between the multimedia component 908 and the processing component 902.

The memory 904 is configured to store various types of data to support the operation of the device 900. Examples of such data include instructions for any applications or methods operated on the device 900, contact data, phonebook data, messages, pictures, video, etc. The memory 904 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 906 provides power to various components of the device 900. The power component 906 may include a power management system, one or more power sources, and any other components associated with the generation, management, and distribution of power in the device 900.

The multimedia component 908 includes a display screen providing an output interface between the device 900 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and other gestures on the touch panel. The touch sensors may not only sense a boundary of a touch or swipe action, but also sense a duration time and a pressure associated with the touch or swipe action. In some embodiments, the multimedia component 908 includes a front camera and/or a rear camera. The front camera and the rear camera may receive external multimedia data while the device 900 is in an operation mode, such as a photographing mode or a video mode. Each of the front camera and the rear camera may be a fixed optical lens system or have focus and optical zoom capability.

The audio component 910 is configured to output and/or input audio signals. For example, the audio component 910 includes a microphone (MIC) configured to receive an external audio signal when the intelligent device 900 is in an operation mode, such as a call mode, a recording mode, and a voice recognition mode. The received audio signal may be further stored in the memory 904 or transmitted via the communication component 916. In some embodiments, the audio component 910 further includes a speaker to output audio signals.

The I/O interface 912 provides an interface for the processing component 902 and peripheral interface modules, such as a keyboard, a click wheel, buttons, and the like. The buttons may include, but are not limited to, a home button, a volume button, a starting button, and a locking button.

The sensor component 914 includes one or more sensors to provide status assessments of various aspects of the device 900. For instance, the sensor component 914 may detect an open/closed status of the device 900 and relative positioning of components (e.g. the display and the keypad of the device 900). The sensor component 914 may also detect a change in position of the device 900 or of a component in the device 900, a presence or absence of user contact with the device 900, an orientation or an acceleration/deceleration of the device 900, and a change in temperature of the device 900. The sensor component 914 may include a proximity sensor configured to detect the presence of nearby objects without any physical contact. The sensor component 914 may also include a light sensor, such as a CMOS or CCD image sensor, for use in imaging applications. In some embodiments, the sensor component 914 may also include an accelerometer sensor, a gyroscope sensor, a magnetic sensor, a pressure sensor, or a temperature sensor.

The communication component 916 is configured to facilitate wired or wireless communication between the device 900 and other devices. The device 900 can access a wireless network based on a communication standard, such as Wi-Fi, 2G, 3G, LTE or 4G cellular technologies, or a combination thereof. In one exemplary embodiment, the communication component 916 receives a broadcast signal or broadcast associated information from an external broadcast management system via a broadcast channel. In one exemplary embodiment, the communication component 916 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 900 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer readable storage medium including instructions, such as the memory 904 including instructions. The above instructions are executable by the processor 920 in the device 900, for performing the above-described methods. For example, the non-transitory computer-readable storage medium may be a ROM, a RAM, a CD-ROM, a magnetic tape, a floppy disc, an optical data storage device, and the like.

A non-transitory computer-readable storage medium having stored therein instructions that, when executed by a processor of a mobile device, causes the mobile device to perform a method for installing a plug-in of a smart device described above.

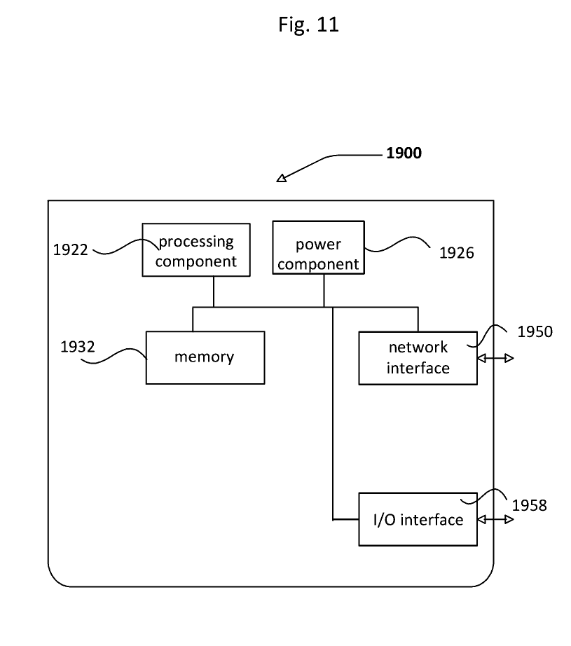

FIG. 11 is a block diagram of a device 1900 for installing a plug-in of a smart device according to another example embodiment. For example, the device 1900 may be provided as a server. Referring to FIG. 11, the device 1900 includes a processing component 1922, which further includes one or more processors, and memory resource represented as a memory 1932, which is configured to store instructions (e.g. an application) executable by the processing component 1922. The application stored in the memory 1932 may include one or more modules, each module corresponding to a set of instructions. In addition, the processing component 1922 is configured to execute instructions, so as to execute the above methods.

The device 1900 may further include a power component 1926 configured to execute power management for the device 1900, a wired or wireless network interface 1950 configured to connect the device 1900 to a network, and an Input/Output (I/O) interface 1958. The device 1900 may operate via an operation system stored in the memory 1932, in which the operation system may be, for example, a Windows Server™, a Mac OS X™, a Unix™, a Linux™, a FreeBSD™ or similar operation systems.

A non-transitory computer-readable storage medium having stored therein instructions that, when executed by a processor of a mobile device, causes the mobile device to perform a method for installing a plug-in of a smart device described above.

Each module or unit discussed above for FIG. 6-9, such as the instruction receiving module, the sending module, the installation package receiving module, the installing module, the obtaining sub-module, the output sub-module, the receiving sub-module, the jumping module, the request receiving module, and the processing module may take the form of a packaged functional hardware unit designed for use with other components, a portion of a program code (e.g., software or firmware) executable by the processor 920 or the processing circuitry that usually performs a particular function of related functions, or a self-contained hardware or software component that interfaces with a larger system, for example.

The illustrations of the embodiments described herein are intended to provide a general understanding of the structure of the various embodiments. The illustrations are not intended to serve as a complete description of all of the elements and features of apparatus and systems that utilize the structures or methods described herein. Other embodiments of the disclosure will be apparent to those skilled in the art from consideration of the specification and practice of the embodiments disclosed herein. This application is intended to cover any variations, uses, or adaptations of the disclosure following the general principles thereof and including such departures from the present disclosure as come within known or customary practice in the art. It is intended that the specification and examples are considered as exemplary only, with a true scope and spirit of the invention being indicated by the following claims in addition to the disclosure

It will be appreciated that the present invention is not limited to the exact construction that has been described above and illustrated in the accompanying drawings, and that various modifications and changes can be made without departing form the scope thereof. It is intended that the scope of the invention only be limited by the appended claims.

What is claimed is:

1. A method for installing a plurality of plug-ins each for a plurality of smart home devices in a mobile terminal, comprising:
receiving a selection instruction for selecting a smart device;
determining whether a plug-in for the smart device was installed previously;
sending a plug-in acquiring request to a server when the plug-in for the smart device was not installed previously, wherein the plug-in acquiring request comprises an identifier of the smart device;
receiving a plug-in installation package for the plug-in sent by the server according to the plug-in acquiring request; and
running the plug-in installation package and installing the plug-in in an application, wherein the application is configured to control the plurality of smart device each via one of the plurality of plug-ins.

2. The method according to claim 1, further comprising:
when the plug-in was previously installed, invoking a user operation interface of the selected smart device included in the previously installed plug-in for the smart device.

3. The method according to claim 1, wherein receiving the selection instruction for selecting the smart device comprises:
obtaining information of a plurality of smart devices sent by the server;
outputting the information of the plurality of smart devices on a smart device selection interface; and
receiving the selection instruction input via the smart device selection interface.

4. The method according to claim 1, further comprising:
invoking a user operation interface of the smart device after installing the plug-in in the application.

5. The method according to claim 1, further comprising:
when the plug-in for the smart device was installed previously, determining a version of the previously installed plug-in for the smart device; and
sending the plug-in acquiring request to the server when the version of the previously installed plug-in is not the latest.

6. A device for installing a plurality of plug-ins each for one of a plurality of smart devices, comprising:
a processor; and
a memory, configured to store instructions executable by the processor;
wherein, the processor is configured to:
receive a selection instruction for selecting a smart device;
determine whether a plug-in for the smart device was installed previously;
send a plug-in acquiring request to a server when the plug-in of the smart device was not installed previously, wherein the plug-in acquiring request comprises an identifier of the smart device;
receive a plug-in installation package for the plug-in sent by the server according to the plug-in acquiring request; and
run the plug-in installation package and install the plug-in in an application, wherein the application is configured to control the plurality of smart devices each via one of the plurality of plug-ins.

7. The device according to claim 6, wherein the processor is further configured to:
invoke a user operation interface of the selected smart device when the plug-in was previously installed.

8. The device according to claim 6, wherein, to receive the selection instruction for selecting the smart device, the processor isr configured to:
obtain information of a plurality of smart devices sent by the server;
output the information of the plurality of smart devices on a smart device selection interface; and
receive the selection instruction input via the smart device selection interface.

9. The device according to claim 6, wherein the processor is further configured to:
invoke a user operation interface of the smart device after installing the plug-in in the application configured to control the plurality of smart devices.

10. The device according to claim 6, wherein the processor is further configured to:
when the plug-in for the smart device was installed previously, determine a version of the previously installed plug-in for the smart device; and
send the plug-in acquiring request to the server when the version of the previously installed plug-in is not the latest.

11. A non-transitory computer-readable storage medium having stored therein instructions that, when executed by a processor of a mobile terminal, cause the mobile terminal to install a plurality of plugins each for one of a plurality of smart devices by:
receiving a selection instruction for selecting a smart device;
determining whether a plug-in for the smart device was installed previously;
sending a plug-in acquiring request to a server when the plug-in of the smart device was not installed previously, wherein the plug-in acquiring request comprises an identifier of the smart device;
receiving a plug-in installation package for the pug-in sent by the server according to the plug-in acquiring request; and
running the plug-in installation package and installing the plug-in in an application, wherein the application is configured to control the plurality of smart devices each via one of the plurality of plug-ins.

12. The storage medium according to claim 11, wherein the instructions, when executed by the processor, further cause the terminal to:
invoke a user operation interface of the selected smart device when the plug-in was previously installed.

13. The storage medium according to claim 11, wherein, receiving the selection instruction for selecting the smart device comprises:
obtaining information of a plurality of smart devices sent by the server;
outputting the information of the plurality of smart devices on a smart device selection interface; and
receiving the selection instruction input via the smart device selection interface.

14. The storage medium according to claim 11, wherein the instructions, when executed by the processor, further cause the terminal to:
invoke a user operation interface of the smart device after installing the plug-in in the application configured to control the plurality of smart devices.

15. The storage medium according to claim 11, wherein the instructions, when executed by the processor, further cause the terminal to:
when the plug-in for the smart device was installed previously, determine a version of the previously installed plug-in for the smart device; and
send the plug-in acquiring request to the server when the version of the previously installed plug-in is not the latest.
